(19) United States
(12) Patent Application Publication
(10) Pub. No.: US 2009/0313422 A1
(43) Pub. Date: Dec. 17, 2009

(54) FLASH MEMORY CONTROL APPARATUS HAVING SEQUENTIAL WRITING PROCEDURE AND METHOD THEREOF

(75) Inventors: Ching-hung Lin, Lujhu Township (TW); Wei-kan Hwang, Taipei City (TW); Hao-wei Li, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/327,055

(22) Filed: Dec. 3, 2008

(30) Foreign Application Priority Data
Jun. 12, 2008 (TW) 097121999

(51) Int. Cl. G06F 12/02; G06F 12/00

(52) U.S. Cl. 711/103; 711/E12.008; 711/E12.001

(57) ABSTRACT

A flash memory control apparatus having a sequential writing procedure and method thereof are described. The flash memory control apparatus includes primary controller, a command module, an address module, a data buffer, a status unit, a counting device and a secondary controller. The primary controller generates a predetermined value which represents the amount of a plurality of pages in the flash memory. The command module stores a writing command during the writing procedure. The address module stores a current address for addressing a current page of the pages based on the current address and the writing command via a control bus. The data buffer stores the data for allowing the command module to write the data to the current page based on the current address via the control bus while the writing command is executed on the flash memory. The status unit determines that the flash memory is either ready or busy in writing the data to the current page of the flash memory. If the command module correctly writes the data to the current page according to the determination result, the address module generates at least one next address. The address module addresses at least one next page of the pages based on the at least one next address and the writing command. The command module sequentially writes the data to the at least one next page during the writing procedure until the pages are written successively.

### FIELD OF THE INVENTION

The present invention relates to a memory apparatus and method thereof, and more particularly relates to a flash memory control apparatus having a sequential writing procedure and method thereof.

### BACKGROUND OF THE INVENTION

NAND (Not AND) flash memory is composed of a plurality of blocks and each of the blocks has a plurality of pages. A small block has the size of 512 bytes and a big block has 2048 bytes. A block is nominally defined as the minimum unit of the writing operation of NAND flash memory. However, a page is physically the minimum unit of the writing operation of NAND flash memory because NAND flash memory needs to be erased sequentially at a block-based before the data are written into the NAND flash memory. Therefore, a “block” is usually the minimum unit of the writing operation of NAND flash memory in view of the erasing mode of NAND flash memory.

Generally speaking, while the NAND flash memory cannot support the sequential writing procedure, the flash controller of the NAND flash memory must repeatedly send a writing command to the NAND flash memory during different writing procedures for writing a next page after a current page in the NAND flash memory is written by the flash controller completely. Due to the repeated commands of the writing procedures, the writing performance of the NAND flash memory is decreased. If a large amount of data should be transmitted to the NAND flash memory correspondingly when the writing commands associated with the data and addresses are sent one by one via the flash controller, the performance of the NAND flash memory is severely degraded.

Consequentially, there is a need to develop a novel flash memory to solve the aforementioned problem.

### SUMMARY OF THE INVENTION

The objective of the present invention is to provide a flash memory control apparatus having a sequential writing procedure and method thereof to sequentially write the pages of the flash memory.

According to the above objective, the present invention sets forth a flash memory control apparatus having a sequential writing procedure and method thereof. The flash memory control apparatus includes a primary controller, a command module, an address module, a data buffer, a status unit, a counting device, a memory unit and a secondary controller.

The primary controller generates a predetermined value which represents the amount of a plurality of pages in the flash memory. The command module stores a writing command during the writing procedure. The address module stores a current address for addressing a current page of the pages based on the current address and the writing command via a control bus. The data buffer stores the data for allowing the command module to write the data to the current page based on the current address via the control bus while the writing command is executed on the flash memory. The status unit determines that the flash memory is either ready or busy in writing the data to the current page of the flash memory.

If the command module correctly writes the data to the current page according to the determination result, the address module generates at least one next address. The address module addresses at least one next page of the pages based on the at least one next address and the writing command. The command module sequentially writes the data to the at least one next page during the writing procedure until the pages are written successively.

According to the above-mention descriptions, during a writing procedure, the data are written into a plurality of pages of the flash memory by the flash memory control apparatus via the control bus. That is, the flash memory control apparatus sequentially programs the pages at one writing procedure to improve the performance of the flash memory. The counting device is used to counts the amount of the pages of the flash memory so that the data are successively written the page. Thus, the address module generates the next address, and it is independent from the firmware in the primary controller. The second controller directly programs the data to the pages according to the predetermined value and the next addresses.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of a flash memory control apparatus having a sequential writing procedure according to one embodiment of the present invention;

FIG. 2 is a schematic timing diagram of a writing procedure of the flash memory control apparatus according to one embodiment of the present invention; and

FIG. 3 is a flow chart of performing the flash memory control apparatus having the sequential writing procedure according to one embodiment of the present invention.

### DETAILED DESCRIPTION OF THE PREFERRED EMBODIMENTS

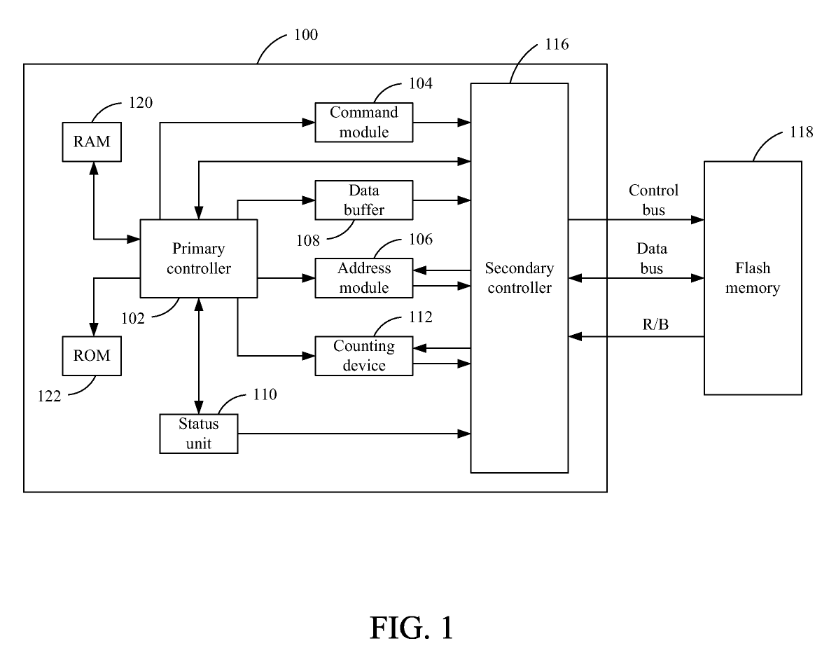

FIG. 1 is a schematic block diagram of a flash memory control apparatus 100 having a sequential writing procedure according to one embodiment of the present invention. The flash memory control apparatus 100 includes a primary controller 102, a command module 104, an address module 106, a data buffer 108, a status unit 110, a counting device 112, a memory unit 114 and a secondary controller 116.

The flash memory control apparatus 100 is coupling to the flash memory 118 via a plurality of control signals, such as the signals compatible to control bus, data bus, and ready/busy bus. In one embodiment, the primary controller 102 is selected from 8051 types of chips, system-on-chip (SOC) and/or digital signal processors (DSPs). For example, the command module 104 is a register for storing the commands and the address module 106 is a register for storing the addresses associated with the command and the data. The secondary controller 116 is a flash controller for allowing the primary controller 102 to control the flash memory 118. The memory unit 114 includes random access memory (RAM) 120 and read only memory (ROM) 122.

The primary controller 102 is coupled to the command module 104, the address module 106, the data buffer 108, the status unit 110, the counting device 112, and the memory unit 114, respectively. The command module 104, the address module 106 106, the data buffer 108, the status unit 110, the counting device 112, and the memory unit 114 are coupled to the secondary controller 116, respectively.

The primary controller 102 generates a predetermined value which represents the amount of a plurality of pages in the flash memory 118. The command module 104 stores a writing command during the writing procedure. The address module 106 stores a current address for addressing a current page of the pages based on the current address and the writing command via a control bus. The data buffer 108 stores the data for allowing the command module 104 to write the data to the current page based on the current address via the control bus while the writing command is executed on the flash memory 118. The status unit 110 determines that the flash memory 118 is either ready or busy in writing the data to the current page of the flash memory 118.

If the command module 104 correctly writes the data to the current page according to the determination result, the address module 106 generates at least one next address for addressing at least one next page of the pages based on the at least one next address and the writing command and the command module 104 sequentially writes the data to the at least one next page during the writing procedure until the pages are written successively.

While the flash memory 118 is busy in writing the data to the current page of the flash memory 118, the status unit 110 continuously monitors the flash memory 118 until the flash memory 118 is ready. If the flash memory 118 is ready, the status unit 110 further reads a writing status of the flash memory 118 via the control bus. For example, the writing status is an input/output (I/O) bit, such as low level or high level. The status unit 110 further determines that the data is correctly written into the flash memory 118 according to the writing status. While the data is correctly written into the flash memory 118 according to the writing status, the counting device 112 of the flash memory control apparatus 100 determines that the current page is the last one of the pages.

If the current page is not the last one page of the pages, one is subtracted from the predetermined value. The address module 106 generates the at least one next address for addressing the at least one next page of the pages and the command module 104 writes the data to the at least one next page during the writing procedure until the predetermined value is zero. If the current page is the last one of the pages, the counting device 112 informs the primary controller 102 that the writing procedure is complete. If the data is incorrectly written into the flash memory 118 because an error point occurs in the current address, a secondary controller 116 records the error point. The secondary controller 116 further informs the primary controller 102 of the error point.

According to the above-mention descriptions, during a writing procedure, the data are written into a plurality of pages of the flash memory 118 by the flash memory control apparatus 100 via the control bus. That is, the flash memory control apparatus 100 sequentially programs the pages at one writing procedure to improve the performance of the flash memory 118. The counting device 112 is used to counts the amount of the pages of the flash memory 118 so that the data are successively written the page. Thus, the address module 106 generates the next address, and it is independent from the firmware in the primary controller 102. The second controller directly programs the data to the pages according to the predetermined value and the next addresses.

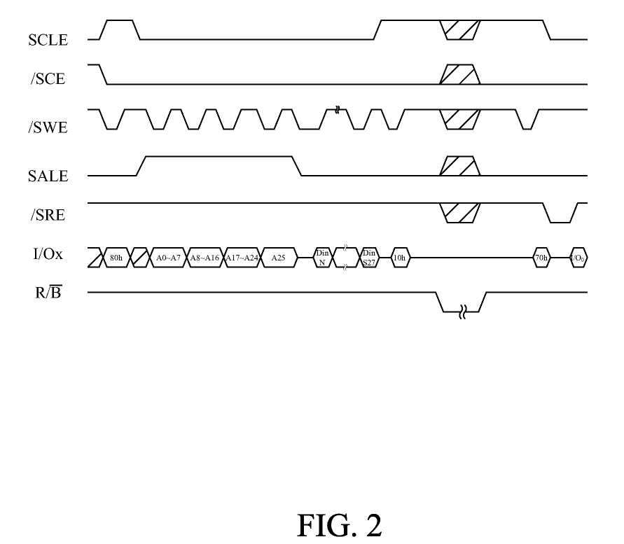

Please refer to FIG. 1 and FIG. 2. FIG. 2 is a schematic timing diagram of a writing procedure of the flash memory control apparatus 100 according to one embodiment of the present invention. The control signals of the flash memory 118 include a command latch enable signal (SCLE), a chip enable signal (/SCE), a write enable signal (/SWE), an address latch enable signal (SALE), a read enable signal (/SRE), an input/output (I/O) signal, and a ready/busy status signal.

The chip enable signal (/SCE) represents that the flash memory 118 is in active status while the flash memory 118 is enabled by the secondary controller 116 of the flash memory control apparatus 100. For example, the flash memory 118 is in active status while the chip enable signal (/SCE) is at low level. The write enable signal (/SWE) represents that the flash memory 118 can be written by the secondary controller 116 of the flash memory control apparatus 100 while the write enable signal (/SWE) is in active status, e.g. at a low level.

The read enable signal (/SRE) represents that the flash memory 118 can be read by the secondary controller 116 of the flash memory control apparatus 100 while the read enable signal (/SRE) is in active status, e.g. at a low level. While the command latch enable signal (SCLE) is in active status, the command is latched to the command module 104 at the rising edge of the write enable signal (/SWE). While the address latch enable signal (SALE) is in active status, the address is latched to the address module 106 at the rising edge of the write enable signal (/SWE).

The input/output (I/O₀) signal represents the data signal transferred between the flash memory 118 and the data buffer 108 of the flash memory control apparatus 100. The ready/busy (R/B) status signal represents the status of the flash memory 118 to be reported to the flash memory control apparatus 100.

While the flash memory control apparatus 100 writes data to the pages of the flash memory 118, the following steps are performed: (1) a writing command, e.g. address 0×80 h, is issued to the flash memory 118; (2) the address is assigned to the flash memory 118 and the data size is corresponding to one page; (3) the writing command, such as address 0×10, is executed; (4) the ready/busy status signal of the flash memory 118 indicates the ready status after the data is written to the page completely; and (5) the status unit 110 of the flash memory control apparatus 100 reads, such as address 0×70, the writing status of the flash memory 118 via the secondary controller 116 for determining that the data is correctly written into the flash memory 118 according to the writing status.

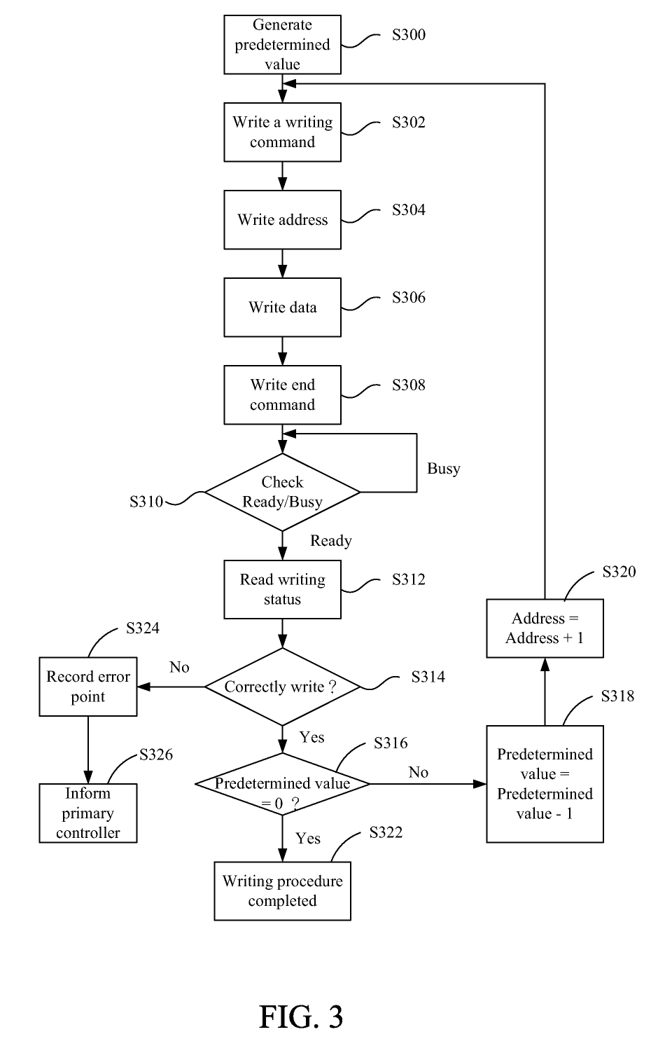

Please refer to FIG. 1, FIG. 2 and FIG. 3. FIG. 3 is a flow chart of performing the flash memory control apparatus 100 having the sequential writing procedure according to one embodiment of the present invention. The method for controlling a writing procedure of a flash memory 118 having the sequential writing procedure includes the following steps of:

In step S300, a primary controller 102 generates a predetermined value which represents the amount of a plurality of pages in the flash memory 118.

In step S302, a command module 104 stores a writing command during the writing procedure.

In step S304, an address module 106 stores a current address for addressing a current page of the pages based on the current address and the writing command via a control bus.

In step S306, a data buffer 108 stores the data for allowing the command module 104 to write the data to the current page based on the current address via the control bus while the writing command is executed on the flash memory 118.

In step S308, the command module 104 writes an end command corresponding to the writing command.

In step S310, a status unit 110 determines that the flash memory 118 is either ready or busy in writing the data to the current page of the flash memory 118. If the flash memory 118 is busy in writing the data to the current page of the flash memory 118, return to step S310 and the status unit 110 continuously monitors the flash memory 118 until the flash memory 118 is ready. If the flash memory 118 is ready, go to step S312. In step S312, the status unit 110 further reads a writing status of the flash memory 118 via the control bus.

In step S314, the status unit 110 determines that the data is correctly written into the flash memory 118 according to the writing status. If the command module 104 correctly writes the data to the current page according to the determination result, the address module 106 generates at least one next address for addressing at least one next page of the pages based on the at least one next address and the writing command and the command module 104 sequentially writes the data to the at least one next page during the writing procedure until the pages are written successively. If the decision in step S314 is yes, go to step S316, and if no, go to step S324.

In step S316, if the data is correctly written into the flash memory 118 according to the writing status, the counting device 112 determines that the current page is the last one of the pages. If no, go to step S318, and if yes, go to step S322.

In step S318, one is subtracted from the predetermined value if the current page is not the last one page of the pages. Proceed to step S320.

In step S320, the address module 106 generates the at least one next address for addressing the at least one next page of the pages and the command module 104 writes the data to the at least one next page during the writing procedure until the predetermined value is zero.

In step S322, the counting device 112 informs the primary controller 102 that the writing procedure is complete if the current page is the last one of the pages.

In step S324, a secondary controller 116 records the error point if the data is incorrectly written into the flash memory 118 because an error point occurs in the current address. Proceed to step S326. In step S326, the secondary controller 116 further informs the primary controller 102 of the error point.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A flash memory control apparatus for controlling a writing procedure of a flash memory, the flash memory control apparatus comprising:
a primary controller generating a predetermined value which represents the amount of a plurality of pages in the flash memory;
a command module, storing a writing command during the writing procedure;
an address module coupled to the primary controller, storing a current address for addressing a current page of the pages based on the current address via a control bus;
a data buffer coupled to the primary controller, storing the data for allowing the command module to write the data to the current page based on the current address via the control bus while the writing command is executed on the flash memory; and
a status unit coupled to the primary controller, determining that the flash memory is either ready or busy in writing the data to the current page of the flash memory;
wherein if the command module correctly writes the data to the current page according to the determination result, the address module generates at least one next address for addressing at least one next page of the pages based on the at least one next address and the writing command and the command module sequentially writes the data to the at least one next page during the writing procedure until the pages are written successively.

2. The flash memory control apparatus of claim 1, wherein if the flash memory is busy in writing the data to the current page of the flash memory, the status unit continuously monitors the flash memory until the flash memory is ready.

3. The flash memory control apparatus of claim 1, wherein if the flash memory is ready, the status unit further reads a writing status of the flash memory via the control bus.

4. The flash memory control apparatus of claim 3, wherein the status unit further determines that the data is correctly written into the flash memory according to the writing status.

5. The flash memory control apparatus of claim 4, wherein if the data is correctly written into the flash memory according to the writing status, the flash memory control apparatus comprises a counting device coupled to the primary controller, determining that the current page is the last one of the pages.

6. The flash memory control apparatus of claim 5, wherein if the current page is not the last one page of the pages, one is subtracted from the predetermined value.

7. The flash memory control apparatus of claim 6, wherein the address module generates the at least one next address for addressing the at least one next page of the pages and the command module writes the data to the at least one next page during the writing procedure until the predetermined value is zero.

8. The flash memory control apparatus of claim 5, wherein if the current page is the last one of the pages, the counting device informs the primary controller that the writing procedure is complete.

9. The flash memory control apparatus of claim 4, wherein if the data is incorrectly written into the flash memory because an error point occurs in the current address, a secondary controller records the error point.

10. The flash memory control apparatus of claim 9, wherein the secondary controller further informs the primary controller of the error point.

11. A method for controlling a writing procedure of a flash memory, the method comprising the steps of:
generating a predetermined value by a primary controller wherein the predetermined value represents the amount of a plurality of pages in the flash memory;
storing a writing command in a command module during the writing procedure;
addressing a current page of the pages based on a current address and the writing command via a control bus by using an address module;
storing the data in a data buffer for allowing the command module to write the data to the current page based on the current address via the control bus while the writing command is executed on the flash memory; and
determining that the flash memory is either ready or busy in writing the data to the current page of the flash memory by using a status unit;
wherein if the command module correctly writes the data to the current page according to the determination result, the address module generates at least one next address, the address module further addresses at least one next page of the pages based on the at least one next address and the writing command, and the command module sequentially writes the data to the at least one next page during the writing procedure until the pages are written successively.

12. The method of claim 11, further comprising a step of continuously monitoring the flash memory until the flash memory is ready if the flash memory is busy in writing the data to the current page of the flash memory.

13. The method of claim 11, further comprising a step of reading a writing status of the flash memory via the control bus if the flash memory is ready.

14. The method of claim 13, further comprising a step of determining that the data is correctly written into the flash memory according to the writing status.

15. The method of claim 14, further comprising a step of determining that the current page is the last one of the pages by using a counting device if the data is correctly written into the flash memory according to the writing status.

16. The method of claim 15, further comprising a step of subtracting one from the predetermined value if the current page is not the last one page of the pages.

17. The method of claim 16, further comprising a step of generating the at least one next address for addressing the at least one next page of the pages and the command module writes the data to the at least one next page during the writing procedure until the predetermined value is zero.

18. The method of claim 15, further comprising a step of informing the primary controller that the writing procedure is complete by the counting device if the current page is the last one of the pages.

19. The method of claim 14, further comprising a step of recording the error point if the data is incorrectly written into the flash memory because an error point occurs in the current address.

20. The method of claim 19, further comprising a step of informing the primary controller of the error point.
